(19) United States
(12) Patent Application Publication
(10) Pub. No.: US 2026/0351091 A1
(43) Pub. Date: Nov. 5, 2026

(54) COMBO FANTASY SPORTS SYSTEM AND METHOD

(71) Applicant: Scott T Keely, Gig Harbor, WA (US)

(72) Inventor: Scott T Keely, Gig Harbor, WA (US)

(21) Appl. No.: 19/197,956

(22) Filed: May 2, 2025

(51) Int. Cl. G07F 17/32; G06Q 50/34

(52) U.S. Cl. CPC G07F 17/3288; G06Q 50/34

(57) ABSTRACT

A method for conducting a multi-sport fantasy league may include receiving selections of two or more distinct real-world sports to be included in a combo fantasy league. A multi-sport draft may be conducted in which participants may select players from any of the included sports to populate their rosters. League play may be managed across seasons of the included sports, which may include processing cross-sport trades between participants. League standings and champions may be determined based on combined performance across the multiple sports. The multi-sport draft may include determining a draft order for participants and iteratively receiving player selections from participants. Each participant may select players from the included sports when it may be their turn. A separate rookie draft may be conducted to allow selection of newly drafted professional players. Cross-sport trades may be processed by receiving proposed trades between participants that may include players from different sports.

### FIELD OF THE INVENTION

### Background

Fantasy sports games have become increasingly popular, allowing participants to act as owners/managers of virtual teams composed of real professional athletes. Traditionally, fantasy sports leagues have focused on a single sport, with participants drafting players and competing based on those players' real-world statistical performance over a season.

While single-sport fantasy leagues provide an engaging experience for fans of a particular sport, there is a desire among some fantasy sports enthusiasts for more diverse and challenging gameplay that spans multiple sports. However, existing fantasy platforms are generally not designed to seamlessly integrate multiple sports into a unified league structure.

Additionally, the typical fantasy sports season is limited to the duration of the real-world sports season being simulated. This can leave fantasy participants with long periods of inactivity between seasons.

Therefore, there is a need for improved fantasy sports systems and methods that can provide a more continuous and multifaceted experience across multiple sports.

### Summary

The present disclosure is directed to systems and methods for conducting a multi-sport fantasy league that combines two or more real-world sports into an integrated fantasy competition. In various embodiments, the disclosed combo fantasy sports system allows participants to draft and manage teams comprising athletes from multiple distinct sports simultaneously.

In one aspect, a method for conducting a multi-sport fantasy league is provided. The method may include: receiving, by a fantasy sports platform, selections of two or more distinct real-world sports to be included in a combo fantasy league; conducting a multi-sport draft in which participants select players from any of the included sports to populate their rosters; managing league play across seasons of the included sports, including processing cross-sport trades between participants; and determining league standings and champions based on combined performance across the multiple sports.

In another aspect, a combo fantasy sports system is provided. The system may include: a league management module configured to set up and administer a fantasy league combining multiple real-world sports; a draft module configured to conduct a multi-sport draft allowing selection of players from any included sport; a scoring engine configured to calculate fantasy points for players across different sports; and a trade processing module configured to handle trades of players between different sports. The present disclosure is directed to systems and methods for conducting a multi-sport fantasy league that combines two or more real-world sports into an integrated fantasy competition. In various embodiments, the disclosed combo fantasy sports system allows participants to draft and manage teams comprising athletes from multiple distinct sports simultaneously.

In one aspect, a method for conducting a multi-sport fantasy league may be provided. The method may include receiving, by a fantasy sports platform, selections of two or more distinct real-world sports to be included in a combo fantasy league. The method may include conducting a multi-sport draft in which participants select players from any of the included sports to populate their rosters. The method may include managing league play across seasons of the included sports, including processing cross-sport trades between participants. The method may include determining league standings and champions based on combined performance across the multiple sports.

In some embodiments, conducting the multi-sport draft may include determining a draft order for participants. The multi-sport draft may include iteratively receiving player selections from participants, wherein each participant may select a player from any of the included sports when it is their turn. The multi-sport draft may include populating team rosters with the selected players. The method may further include conducting a separate rookie draft to allow selection of newly drafted professional players.

In some embodiments, processing cross-sport trades may include receiving a proposed trade between two participants that includes players from different sports. Processing cross-sport trades may include evaluating the proposed trade for compliance with league rules. Processing cross-sport trades may include updating team rosters to reflect the trade if approved. Processing cross-sport trades may include recalculating scoring as needed to account for the traded players.

In some embodiments, determining league standings and champions may include tracking team performance separately for each included sport. Determining league standings and champions may include calculating sport-specific standings based on performance in each particular sport. Determining league standings and champions may include determining an overall combo ranking by combining and weighting the standings from the individual sports. Determining league standings and champions may include crowning both individual sport champions and an overall league champion. Some fantasy sports may not use points to determine head-to-head winners, but rather the scoring system may track categories, and whoever wins the most categories may win that matchup. For example, a standard fantasy baseball league may use 10 categories, commonly referred to as 5×5 scoring, meaning 5 hitting categories (batting average, runs scored, home runs, RBIs, steals) and 5 pitching categories (wins, saves, strikeouts, ERA, and WHIP). Each individual category may be compared head-to-head with an opponent, and whoever wins more categories may win the matchup. The main purpose of Combo Fantasy Sports may be to offer total customization rather than having a singular scoring system for all sports.

The method may further include processing keeper selections for a subsequent season, wherein participants may retain a specified number of players across the multiple sports. The method may further include determining initial waiver wire priority for one sport based on performance in another sport.

In another aspect, a combo fantasy sports system may be provided. The system may include a league management module configured to set up and administer a fantasy league combining multiple real-world sports. The system may include a draft module configured to conduct a multi-sport draft allowing selection of players from any included sport. The system may include a scoring engine configured to calculate fantasy points for players across different sports. The system may include a trade processing module configured to handle trades of players between different sports.

The system may further include a data integration layer configured to obtain real-world player statistics from external data providers for the multiple included sports. The system may further include a user interface module configured to generate interfaces displaying roster, matchup, and standings information across the multiple sports. The league management module may be further configured to determine initial waiver wire priority for one sport based on performance in another sport. The scoring engine may be configured to calculate both sport-specific standings and an overall combo ranking across the multiple sports. The draft module may be further configured to conduct a separate rookie draft for newly drafted professional players. The league management module may be further configured to process keeper selections allowing participants to retain a specified number of players across the multiple sports for a subsequent season.

In another aspect, a non-transitory computer-readable medium containing instructions that, when executed, may cause a processor to perform operations for administering a multi-sport fantasy league. The operations may include initializing league parameters for multiple sports. The operations may include conducting a unified draft across the multiple sports. The operations may include processing roster moves including cross-sport trades. The operations may include calculating scores and standings across the multiple sports. The operations may include determining overall league champions based on combined performance in the multiple sports.

In another aspect, a non-transitory computer-readable medium containing instructions that, when executed, may cause a processor to perform operations for administering a multi-sport fantasy league. The operations may include conducting the unified draft allowing participants to select players from any of the included sports when it is their turn in the draft order. Processing roster moves may include evaluating proposed trades involving players from different sports for compliance with league rules. Calculating scores and standings may include tracking performance separately for each included sport. Calculating scores and standings may include determining sport-specific rankings. Calculating scores and standings may include calculating an overall combo ranking by combining the sport-specific rankings. The operations may further include determining initial waiver wire priority for one sport based on performance in another sport. The operations may further include processing keeper selections allowing participants to retain a specified number of players across the multiple sports for a subsequent season.

In a further aspect, a non-transitory computer-readable medium is provided containing instructions that, when executed, cause a processor to perform operations for administering a multi-sport fantasy league. The operations may include: initializing league parameters for multiple sports; conducting a unified draft across the multiple sports; processing roster moves including cross-sport trades; calculating scores and standings across the multiple sports; and determining overall league champions based on combined performance in the multiple sports.

These and other aspects, features, and advantages will be apparent from the following detailed description and accompanying drawings.

### BRIEF DESCRIPTION OF THE DRAWINGS

FIG. 1 is a block diagram illustrating an exemplary combo fantasy sports system according to some embodiments.

FIG. 2 is a flowchart illustrating an exemplary method for conducting a multi-sport fantasy draft according to some embodiments.

FIG. 3 is a flowchart illustrating an exemplary method for processing cross-sport trades in a combo fantasy league according to some embodiments.

FIG. 4 is a flowchart illustrating an exemplary method for determining league standings and champions in a combo fantasy league according to some embodiments.

FIG. 5 is a diagram illustrating an exemplary user interface for a combo fantasy sports platform according to some embodiments.

### DETAILED DESCRIPTION

In the following detailed description, reference is made to the accompanying drawings, which form a part hereof. In the drawings, similar symbols typically identify similar components, unless context dictates otherwise. The illustrative embodiments described in the detailed description, drawings, and claims are not meant to be limiting. Other embodiments may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

The present disclosure is directed to systems and methods for conducting fantasy sports leagues that combine multiple real-world sports into an integrated competition. While traditional fantasy sports typically focus on a single sport, the combo fantasy sports system described herein allows participants to draft and manage teams comprising athletes from two or more distinct sports simultaneously. This provides a more diverse and engaging experience that spans multiple sports seasons.

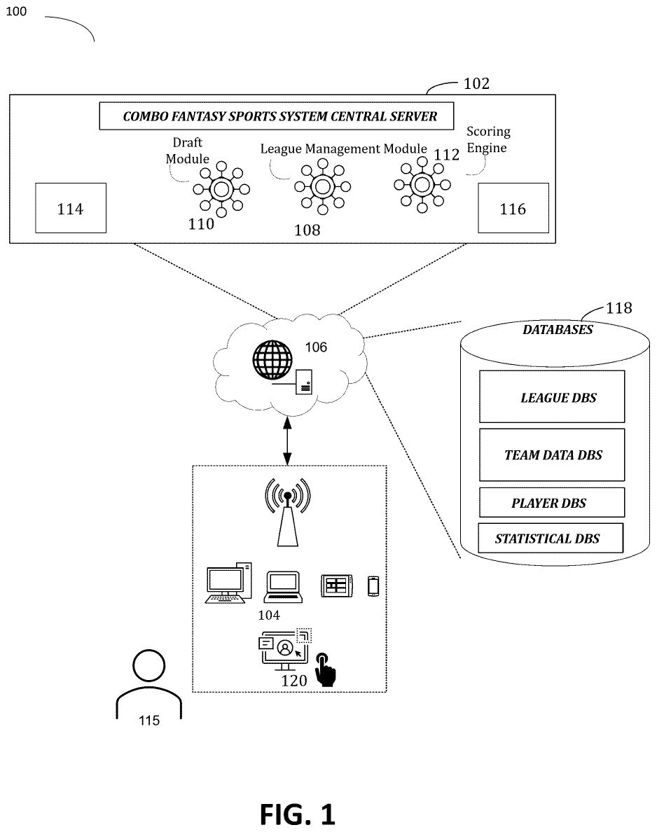

FIG. 1 illustrates an exemplary combo fantasy sports system 100 according to some embodiments. The system 100 may include a central server 102 that hosts the various modules and components for administering the multi-sport fantasy league. The central server 102 may be in communication with user devices 104 (e.g. computers, smartphones, tablets) via a network 106 such as the internet. The central server 102 may include a league management module 108 for setting up and administering the overall league structure and rules. A draft module 110 may be provided to conduct the multi-sport draft process. A scoring engine 112 may calculate fantasy points for players across the different included sports. A trade processing module 114 may handle trades between participants, including cross-sport trades. A data integration layer 116 may interface with external sports statistics providers to obtain real-world player performance data. The system 100 may also include one or more databases 118 for storing league, team, player, and statistical information. A user interface module 120 may generate the front-end interfaces displayed to participants on their user devices 104 enabling a user 115 to have access.

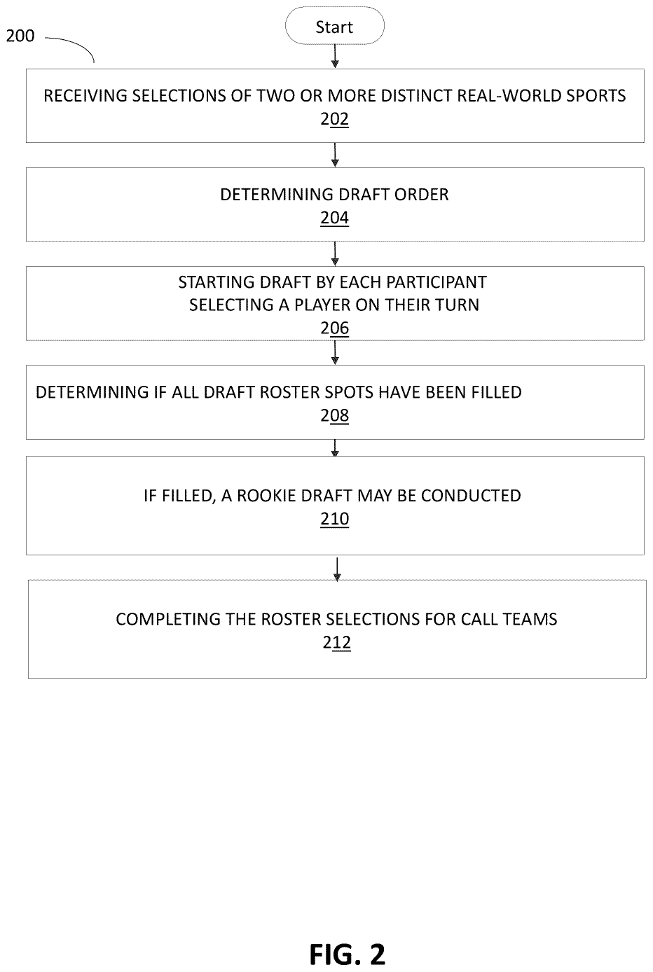

FIG. 2 illustrates an exemplary method 200 for conducting a multi-sport fantasy draft according to some embodiments. The method 200 may begin at step 202 with receiving selections of two or more distinct real-world sports to be included in the combo fantasy league. For example, participants may vote on or the league commissioner may select which sports to include, such as football and baseball. At step 204, the draft order may be determined, for example by random selection. The draft may then proceed at step 206 with each participant selecting a player from any of the included sports when it is their turn. This allows participants to strategically balance their rosters across the different sports. At step 208, it may be determined if all roster spots have been filled for all teams. If not, the draft continues at step 206. If rosters are full, an optional rookie draft may be conducted at step 210 to allow selection of newly drafted professional players. The method then ends at step 212 with completed multi-sport rosters for all teams.

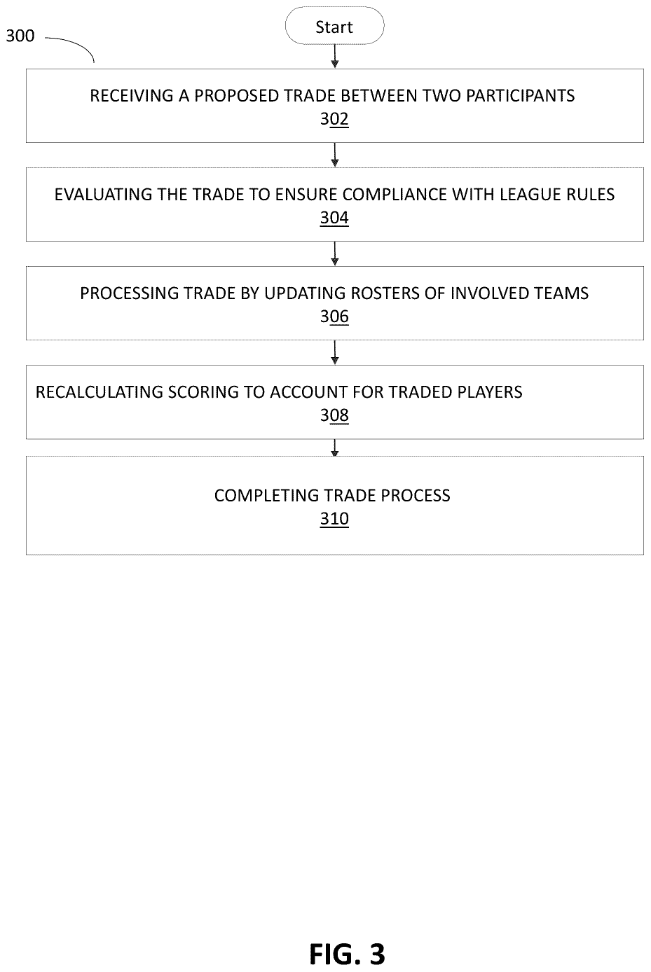

FIG. 3 illustrates an exemplary method 300 for processing cross-sport trades in a combo fantasy league according to some embodiments. The method 300 may begin at step 302 with receiving a proposed trade between two participants that includes players from different sports. For example, a baseball player may be traded for a football player. At step 304, the trade may be evaluated to ensure it complies with league rules, such as roster limits for each sport. If the trade is valid, it may be processed at step 306 by updating the rosters of the involved teams. Scoring may then be recalculated as needed at step 308 to account for the traded players. The method ends at step 310.

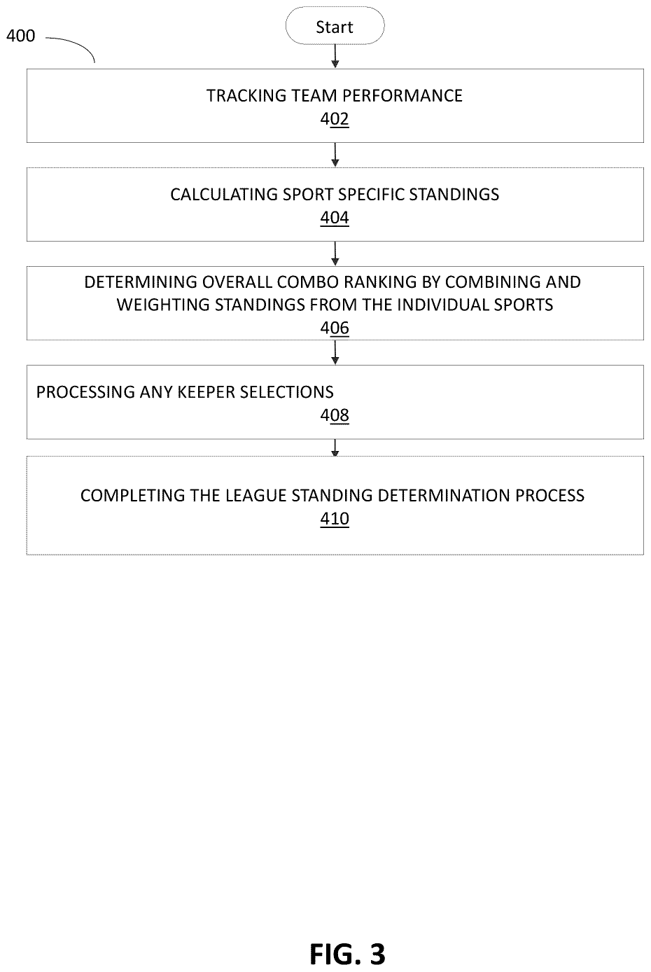

FIG. 4 illustrates an exemplary method 400 for determining league standings and champions in a combo fantasy league according to some embodiments. The method 400 may begin at step 402 with tracking team performance separately for each included sport over their respective seasons. At step 404, sport-specific standings may be calculated based on each team's performance in that particular sport. An overall combo ranking may then be determined at step 406 by combining and weighting the standings from the individual sports. This allows for crowning both individual sport champions and an overall league champion. At step 408, any keeper selections for the following season may be processed, allowing participants to retain a certain number of players across the multiple sports. The method then ends at step 410.

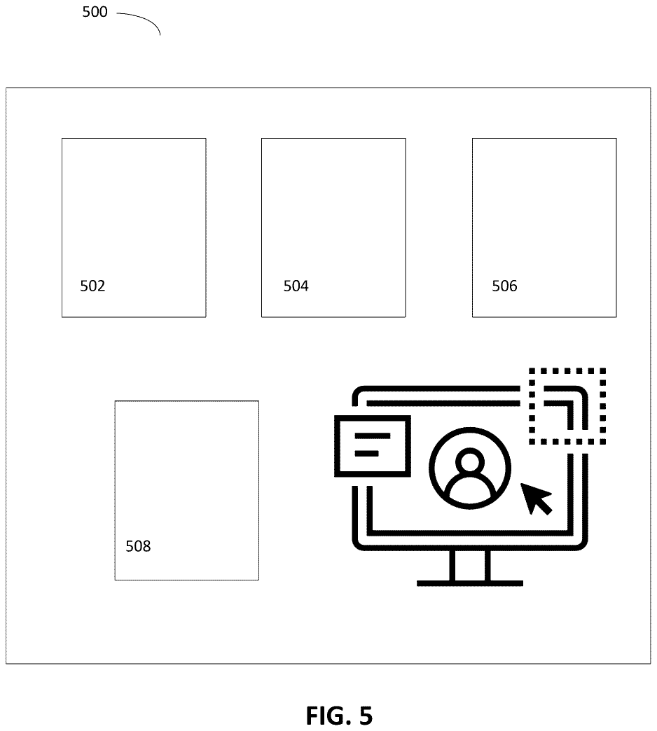

FIG. 5 illustrates an exemplary user interface 500 for a combo fantasy sports platform according to some embodiments. The interface 500 may include tabs 502 for switching between views for the different included sports. A roster section 504 may display the user's current players across all sports. Upcoming matchups 506 may be shown for the active sports seasons. League standings 508 may include both sport-specific and overall combo rankings.

The fantasy sports platform may receive selections of two or more distinct real-world sports to be included in a combo fantasy league. The platform may conduct a multi-sport draft in which participants select players from any of the included sports to populate their rosters. The draft may be conducted by determining a draft order for participants and iteratively receiving player selections from participants, wherein each participant may select a player from any of the included sports when it is their turn. The platform may populate team rosters with the selected players.

Each participant may select a player from any of the included sports when it may be their turn or choose a draft slot in a future Rookie Draft, for incoming professional NFL players, if the Combo Fantasy league being played includes football and baseball. This option provides additional strategic depth to the draft process, allowing participants to secure priority positions for selecting newly drafted professional NFL players. The scoring system may vary depending on the specific sports included in the league. For example, some fantasy sports may utilize a points-based scoring system where participants accumulate points based on their players' statistical performances, while others may employ a categories-based approach where participants compete head-to-head across multiple statistical categories. In a categories-based system, such as those commonly used in fantasy baseball leagues, participants may compete across ten categories, often referred to as 5×5 scoring. This typically includes five hitting categories (batting average, runs scored, home runs, RBIs, and steals) and five pitching categories (wins, saves, strikeouts, ERA, and WHIP). Each category may be compared head-to-head with an opponent, and the participant who wins more categories may win the matchup. This differs from points-based systems where participants might win by accumulating more total points, such as 125-117.

The Combo Fantasy Sports system may provide total customization of scoring systems rather than imposing a singular scoring system for all sports. This approach may allow league commissioners to maintain the integrity and familiar mechanics of each individual sport while still combining them into an integrated competition. If rosters are full, an optional rookie draft may be conducted at step 210 to allow selection of newly drafted professional NFL players for leagues that are drafting prior to the NFL draft in April of each year. This rookie draft may be particularly relevant for Combo Fantasy leagues that include both baseball and football due to the timing differences between the MLB and NFL seasons and drafts.

League standings may be determined using various customizable options. These may include combined winning percentage across both sports, all-play winning percentage across both sports (where participants track their head-to-head record against each team each week, not just their scheduled opponent), or where participants finish in final individual league standings across both sports. The system may allow league commissioners to choose how to combine and weight these standings to determine overall champions.

The Combo Fantasy Sports system may also support keeper leagues, allowing participants to retain a certain number of players across the multiple sports for subsequent seasons. This feature may add another layer of strategy to the game, as participants may need to balance their keeper selections across different sports. The cross-sport draft, cross-sport trading, and cross-sport keeper options may create new strategic dimensions that traditional single-sport fantasy leagues may not offer. Additionally, the combined scoring option may create a more holistic competition that rewards success across multiple sports rather than excellence in just one sport.

The Combo Fantasy Sports system may provide participants with the option to select a draft slot in a future Rookie Draft as an alternative to selecting a player during their turn in the multi-sport draft. This feature may be particularly relevant when the Combo Fantasy league includes football and baseball due to the timing of the NFL draft relative to the MLB and NFL seasons. When a participant may choose a draft slot in the future Rookie Draft, they may effectively secure priority position for selecting newly drafted professional NFL players who may enter the league after the initial multi-sport draft has concluded.

For fantasy sports that utilize category-based scoring systems rather than points-based systems, the Combo Fantasy Sports platform may accommodate these different scoring methodologies across the included sports. In a standard fantasy baseball league, for example, the scoring system may track ten categories, commonly referred to as 5×5 scoring. The five hitting categories may include batting average, runs scored, home runs, RBIs (runs batted in), and steals, while the five pitching categories may include wins, saves, strikeouts, ERA (earned run average), and WHIP (walks and hits per inning pitched). In this category-based approach, each individual category may be compared head-to-head with an opponent's corresponding category, and the participant who wins more categories may win the matchup. This may differ substantially from points-based systems where participants might win by accumulating a higher total point value.

The Combo Fantasy Sports system may not impose a singular scoring system for all included sports but may instead allow league commissioners to customize scoring systems for each sport included in the combo league. This approach may preserve the integrity and familiar mechanics of each individual sport while still combining them into an integrated competition. The flexibility in scoring systems may allow participants to experience each sport in its traditional format while still competing in the overall combo league.

When conducting the optional rookie draft at step 210, the system may specifically focus on newly drafted professional NFL players for leagues that may be drafting prior to the NFL draft in April of each year. This timing consideration may be particularly important for Combo Fantasy leagues that include both baseball and football, as the MLB season may typically begin before the NFL draft occurs. The rookie draft may allow participants to select incoming professional players who may not have been available during the initial multi-sport draft.

For determining league standings and champions, the Combo Fantasy Sports system may offer various customizable options for calculating the overall combo rankings. These options may include combined winning percentage across both sports, all-play winning percentage across both sports, or placement in final individual league standings across both sports. In the all-play winning percentage method, participants may track their head-to-head record against each team each week, not just their scheduled opponent. League commissioners may be able to choose how to combine and weight these standings to determine the overall champion in a way that best suits their league's preferences.

The keeper selection feature may add another strategic dimension to the Combo Fantasy Sports system by allowing participants to retain a certain number of players across the multiple sports for subsequent seasons. Participants may have the flexibility to distribute their keeper selections across the different sports according to their strategic preferences. For example, in a league that allows five total keepers, a participant may choose to keep four football players and one baseball player, or three football players and two baseball players, or any other combination that may fit within the total keeper allowance.

The cross-sport draft, cross-sport trading, and cross-sport keeper options may create new strategic dimensions that traditional single-sport fantasy leagues may not offer. Participants may need to evaluate player value not only within the context of a single sport but also relative to players in other sports included in the combo league. The combined scoring option may create a more holistic competition that rewards success across multiple sports rather than excellence in just one sport, potentially encouraging participants to develop broader sports knowledge and more balanced team management strategies.

The system described herein may provide various customization options for fantasy sports leagues beyond those previously discussed. Fantasy leagues typically offer numerous configuration options related to scoring, roster size, waiver wire systems, and other parameters. The combo fantasy sports system may support all of these standard customization options while adding the unique multi-sport integration features. Each sport included in a combo fantasy league may be configured with its own specific scoring system. For example, in a football and baseball combo league, the football portion may use standard or point-per-reception (PPR) scoring, while the baseball portion may use rotisserie or head-to-head scoring. The league commissioner may set these parameters during league creation through the league management module 108. Roster sizes may be customized separately for each sport in the combo league. A league may choose to have larger rosters for one sport compared to another based on participant preferences. This flexibility may allow leagues to emphasize certain sports while still maintaining competitive balance across all included sports.

In one or more embodiments, the waiver wire system may incorporate cross-sport considerations as previously described. In addition to using standings in one sport to determine waiver priority in another, the system may support various waiver claim methods including first-come-first-served, waiver budget systems, or rolling priority lists. These waiver systems may be configured separately for each sport or unified across all sports in the combo league. The scoring engine 112 may include a hypothetical scoring capability that allows participants to simulate how their teams might perform under different scoring configurations or with different roster compositions. This feature may be particularly valuable in a multi-sport context where strategic decisions about resource allocation between sports may significantly impact overall performance. The trade processing module 114 may support complex multi-team trades involving players from different sports. For example, a three-team trade might involve Team A sending a football player to Team B, Team B sending a baseball player to Team C, and Team C sending a football player back to Team A. The system may evaluate these complex trades for fairness and compliance with league rules before processing them.

In one or more embodiments, the league management module 108 may track and crown individual sport champions separately from the overall combo champion. This may allow participants to compete for multiple titles within the same league structure. For example, in a football and baseball combo league, one team might win the football championship, another might win the baseball championship, and a third might win the overall combo championship based on their combined performance across both sports. The draft module 110 may support various draft formats beyond the standard snake draft, including auction drafts where participants bid on players using a virtual budget, keeper drafts where certain players are retained from previous seasons, and dynasty drafts where most or all players are kept from year to year. These draft options may be configured separately for each sport or applied uniformly across the combo league.

In one or more embodiments, the system may also support in-season mini-games or competitions that span multiple sports. For example, a special weekly prize might be awarded to the team whose combined roster scores the most points across all included sports during that period. These supplementary competitions may add additional engagement opportunities without affecting the main league structure. The data integration layer 116 may incorporate advanced analytics and projection tools that account for the multi-sport nature of the combo league. These tools may help participants evaluate trade offers that involve players from different sports by providing normalized value comparisons across sports.

In one or more embodiments, the user interface module 120 may include customizable dashboard views that allow participants to focus on specific sports or see a comprehensive overview of their performance across all sports in the combo league. These interface options may help participants manage the increased complexity of multi-sport fantasy competition. The system may also include social and communication features specifically designed for the multi-sport context, such as sport-specific discussion forums, trade blocks where participants can list players they're willing to trade from each sport, and notification systems that alert participants to relevant events across all included sports.

Through these various customization options, the combo fantasy sports system may provide a highly flexible framework that can accommodate diverse participant preferences while maintaining the core multi-sport integration features that distinguish it from traditional single-sport fantasy leagues. The platform may manage league play across seasons of the included sports. This may involve processing cross-sport trades between participants. Processing cross-sport trades may include receiving a proposed trade between two participants that includes players from different sports, evaluating the proposed trade for compliance with league rules, updating team rosters to reflect the trade if approved, and recalculating scoring as needed to account for the traded players.

The platform may determine league standings and champions based on combined performance across the multiple sports. This may involve tracking team performance separately for each included sport, calculating sport-specific standings based on performance in each particular sport, determining an overall combo ranking by combining and weighting the standings from the individual sports, and crowning both individual sport champions and an overall league champion.

The platform may process keeper selections for a subsequent season, wherein participants may retain a specified number of players across the multiple sports. The platform may also determine initial waiver wire priority for one sport based on performance in another sport.

The system may include a league management module configured to set up and administer a fantasy league combining multiple real-world sports, a draft module configured to conduct a multi-sport draft allowing selection of players from any included sport, a scoring engine configured to calculate fantasy points for players across different sports, and a trade processing module configured to handle trades of players between different sports. The system may also include a data integration layer configured to obtain real-world player statistics from external data providers for the multiple included sports and a user interface module configured to generate interfaces displaying roster, matchup, and standings information across the multiple sports.

The combo fantasy sports system and methods described herein provide numerous advantages over traditional single-sport fantasy leagues. By integrating multiple sports, participants can enjoy year-round engagement as different sports seasons overlap. The cross-sport draft and trading adds new layers of strategy. And the combined scoring creates a more holistic competition that rewards success across multiple sports.

While specific embodiments have been described above, it will be appreciated that the invention may be practiced otherwise than as described. The descriptions above are intended to be illustrative, not limiting. Thus, it will be apparent to one skilled in the art that modifications may be made to the invention as described without departing from the scope of the claims set out below.

What is claimed is:

1. A method for conducting a multi-sport fantasy league, the method comprising:
receiving, by a fantasy sports platform, selections of two or more distinct real-world sports to be included in a combo fantasy league;
conducting a multi-sport draft in which participants select players from any of the included sports to populate their rosters;
managing league play across seasons of the included sports, including processing cross-sport trades between participants; and
determining league standings and champions based on combined performance across the multiple sports.

2. The method of claim 1, wherein conducting the multi-sport draft comprises:
determining a draft order for participants;
iteratively receiving player selections from participants, wherein each participant may select a player from any of the included sports when it is their turn; and
populating team rosters with the selected players.

3. The method of claim 2, further comprising conducting a separate rookie draft to allow selection of newly drafted professional players.

4. The method of claim 1, wherein processing cross-sport trades comprises:
receiving a proposed trade between two participants that includes players from different sports;
evaluating the proposed trade for compliance with league rules;
updating team rosters to reflect the trade if approved; and
recalculating scoring as needed to account for the traded players.

5. The method of claim 1, wherein determining league standings and champions comprises:
tracking team performance separately for each included sport;
calculating sport-specific standings based on performance in each particular sport;
determining an overall combo ranking by combining and weighting the standings from the individual sports; and
crowning both individual sport champions and an overall combo fantasy league champion.

6. The method of claim 1, further comprising processing keeper selections for a subsequent season, wherein participants may retain a specified number of players across the multiple sports.

7. The method of claim 1, further comprising determining initial waiver wire priority for one sport based on performance in another sport.

8. A combo fantasy sports system comprising:
a league management module configured to set up and administer a fantasy league combining multiple real-world sports;
a draft module configured to conduct a multi-sport draft allowing selection of players from any included sport;
a scoring engine configured to calculate fantasy points for players across different sports; and
a trade processing module configured to handle trades of players between different sports.

9. The system of claim 8, further comprising a data integration layer configured to obtain real-world player statistics from external data providers for the multiple included sports.

10. The system of claim 8, further comprising a user interface module configured to generate interfaces displaying roster, matchup, and standings information across the multiple sports.

11. The system of claim 8, wherein the league management module is further configured to determine initial waiver wire priority for one sport based on performance in another sport.

12. The system of claim 8, wherein the scoring engine is configured to calculate both sport-specific standings and an overall combo ranking across the multiple sports.

13. The system of claim 8, wherein the draft module is further configured to conduct a separate rookie draft for newly drafted professional players.

14. The system of claim 8, wherein the league management module is further configured to process keeper selections allowing participants to retain a specified number of players across the multiple sports for a subsequent season.

15. A non-transitory computer-readable medium containing instructions that, when executed, cause a processor to perform operations for administering a multi-sport fantasy league, the operations comprising:
initializing league parameters for multiple sports;
conducting a unified draft across the multiple sports;
processing roster moves including cross-sport trades;
calculating scores and standings across the multiple sports; and
determining overall league champions based on combined performance in the multiple sports.

16. The computer-readable medium of claim 15, wherein conducting the unified draft comprises allowing participants to select players from any of the included sports when it is their turn in the draft order.

17. The computer-readable medium of claim 15, wherein processing roster moves comprises evaluating proposed trades involving players from different sports for compliance with league rules.

18. The computer-readable medium of claim 15, wherein calculating scores and standings comprises:
tracking performance separately for each included sport;
determining sport-specific rankings; and
calculating an overall combo ranking by combining the sport-specific rankings.

19. The computer-readable medium of claim 15, wherein the operations further comprise determining initial waiver wire priority for one sport based on performance in another sport.

20. The computer-readable medium of claim 15, wherein the operations further comprise processing keeper selections allowing participants to retain a specified number of players across the multiple sports for a subsequent season.
